(19) United States
(12) Patent Application Publication
(10) Pub. No.: US 2002/0168082 A1
(43) Pub. Date: Nov. 14, 2002

(54) Real-time, distributed, transactional, hybrid watermarking method to provide trace-ability and copyright protection of digital content in peer-to-peer networks

(76) Inventor: Ravi Razdan, Del Mar, CA (US)

Correspondence Address: STREAMTONE, INC, 2683 VIA DE LA VALLE, G-427, DELMAR, CA, 92014, US

(21) Appl. No.: 09/799,509

(22) Filed: Mar. 7, 2001

(51) Int. Cl. G06K 9/00

(52) U.S. Cl. 382/100

(57) ABSTRACT

A method of enabling real-time watermarking of digital works prior to distribution of digital work. The method entails maintaining a central repository of fingerprint meta-data of digital works so that upon a request for insertion of watermark in a digital work, the watermarking application communicates with the central repository and receives fingerprint meta-data which provides information regarding where to insert said watermarks. The method also enables a method of extraction of watermarks based on fingerprint meta-data. Furthermore, the fingerprint meta-data can be utilized to search for digital works of similar characteristics and to block digital works that are illegal copies of the digital work.

### BACKGROUND OF THE INVENTION

1. Field of Invention

The invention relates to digital signal processing and digital content such as digital audio, video, image, and text data. Specifically, the invention relates to a method for real-time analysis of digital content, real-time remote embedding of imperceptible watermarks using fingerprint meta-data and asymmetric cryptography. It also relates to the extraction of said watermark remotely from such content using fingerprints, resonant frequency and a private key to provide trace-ability and copyright protection of digital content.

2. Related Art

The progress in multimedia storage and transmission technology allows storage and transmission of an ever-increasing amount of information in digital format. This possibility has greatly expanded by the advent of the World Wide Web. Advances in digital media compression and e-commerce have created a new distribution channel for content producers. A great pitfall of digital content is the potential for unrestricted copying. A perfect digital copy of digital content is possible fairly easily where as analog content cannot be copied as easily. Therefore, there is a need for technologies that securely distribute digital content while allowing trace-ability.

In the current Internet environment, content producers with valuable content are reluctant to use the immense potential of the distribution medium to distribute their content. These content producers are wary of unrestricted piracy over the Internet as illustrated by the popular Internet sites such as Napster.com and Mp3.com. Content producers would like to protect copyrights, while at the same time harness the immense distribution potential of Internet. They would also like to avoid incurring high costs associated with copyright protection of digital content. They would ideally like to gather information regarding how and when digital content was purchased, used or procured through a copyright violation

Digital watermarking is one of the enabling technologies in the digital rights management framework. Digital watermarking makes possible to identify the source, author, creator, owner, distributor or authorized consumer of digitized images, video recordings or audio recordings. A digital watermark is an identification code, permanently embedded into digital data, carrying information pertaining to copyright protection and data authentication. Because the watermark allows unique identification of copyright owners, buyers and distributors, it provides a strong deterrent to illegal copying. It is a mechanism whereby a master file and any of its derivatives may be differentiated. The derivative files will contain identification information of the original and will indicate that the derivative file is an illegal copy of the master.

Generally, digital watermarking is achieved when a pattern of bits is inserted into a digital image, audio or video file that identifies the file's copyright information (author, rights, etc.). The watermarks can also provide an audit trail allowing for each copyright owner, distributor and retailer in the value chain to insert information regarding the particular transaction, addresses, billing and pricing information. Unlike printed watermarks, which are intended to be somewhat visible, digital watermarks are designed to be completely invisible and/or inaudible. Moreover, the actual bits representing the watermark must be scattered throughout the file in such a way that they cannot be identified and manipulated. The digital watermark must also be robust enough so that it can withstand normal changes to the file, such as compression, filtering, addition of noise, resizing, transcoding and multiple conversions. It must also prevent attackers from finding and deleting it, it should be easily detectable so that data owners can detect and extract it, it should also be unambiguous so that the identity of the owner is unambiguously established and must be innumerable, that is, it must be able to generate a great number of watermarks that are indistinguishable. Additionally, to view a watermark, you need a special program that knows how to extract the watermark data.

Due to the real-time and distributed nature of Internet, there is a need for a watermarking technique that watermarks in real-time and instantaneously that is it is capable of being watermarked in a matter of seconds and remotely. That is, the watermark must be inserted at the time of distribution from one party to another. For example, Distribution of digital work over the Internet entails several participants, from a content producer, distributor to e-tailer and finally to a consumer. Therefore, when a distributor of digital content engages in distribution to an e-tailer, the watermarking technique will insert a watermark describing the association. The distributor-to-distributor association can also serve to provide an audit-trail of the content. Watermarking techniques thus far, involve staged content so that content producers or distributors insert watermarks and then pass on the watermarked content. Previous techniques therefore, involved significant lag time such that watermarking content before delivery may entail several days. Also, the watermarks that are generated must uniquely identify the digital content that is distributed. They must also be robust enough that they withstand multiple analog to digital conversions. Watermarking technique must also be able to watermark digital content that is audio, video, image and text as Internet distribution enables deliveries of digital content that is audio, video, image, text or a combination of these. Lastly, the watermarking technique should be able to watermark in both static mode as well as streaming mode of distribution as digital content over the Internet may either be static or may be streamed.

Therefore, a system of watermarking that avoids additional costs to content producers that is robust, that can be inserted in different mediums in real-time, that will also assist in providing an audit-trail and copyright protection is necessary.

### SUMMARY OF THE INVENTION

The invention provides a system for watermarking digital content so that a watermark is generated that is unique to the digital content, the owner and licensee, it is inserted in real-time, distributed, and is robust. The invention provides a method of real-time insertion of watermarks in a digital file prior to digital distribution or streaming of said file. The method entails collecting fingerprint meta-data of a digital work for the insertion of the watermark in said digital file, stream and while a transaction to purchase said digital file is completed. The invention also provides a method of extracting the said watermark. The watermarks may be automatically embedded, in multiple layers at each transactional stage to provide a complete audit trail of digital file. In one embodiment, these watermarking services enable real-time watermarking of a digital work being delivered to a customer such that the watermark(s) identifies an association between the provider, the customer, the retailer, the clearinghouse or some combination of these, for that transaction, thereby enabling trace-ability. A watermark, therefore, is any information regarding the transaction or association between parties to the transaction, copyright information such as the author, year, or owner of digital content, it may also be any meta-data of the digital work.

This embodiment discloses a watermarking technique that can watermark in real-time at the time of purchase or consumption, a piece of digital content such as music, video stream, image or text bought from a distributor. The step includes maintaining a database of meta-data that includes the mathematical analysis or fingerprint of the digital work so that the watermarking application can insert watermarks in the appropriate place at a given time.

This embodiment of the invention provides a system in which a watermark is generated that is unique to each digital content by using a digital fingerprint that uniquely identifies the digital content, is robust, will survive all known attacks including multiple encoding cycles, multiple Analog to Digital conversions, up and down sampling, jitter attacks, and running through some high-end music industry-specific specialized codec.

This embodiment of the invention also provides a mechanism by which digital content is securitized so that it is immune to hacker attacks by utilizing asymmetric cryptography.

This embodiment of the invention also enables the watermarks to be distributed so that a watermark can be inserted at any point of presence, download location or data center in the world.

This embodiment of the invention also enables the watermarking application to insert watermarks at each transactional stage so that up to eight layers of watermarks can be put in a digital work, thus providing a complete audit trail right from mastering, distribution, label encoding, e-tailer to consumer.

This embodiment of the invention also enables a method of watermark extraction that is automated and web-based providing complete detail on the audit trail for the complete content so that a content provider may determine if there is any copyright infringement.

This embodiment of the invention also enables a method of searching for other similar digital works based on the meta-data of the digital work that is already available.

This embodiment of the invention also enables a method of blocking digital works suspected of being procured through copyright violation by matching the digital works that are suspected of being illegal copies with those that are the legitimate copies.

Further features and advantages of the invention as well as the structure and operation of various embodiments of the invention are described in detail below with reference to the accompanying drawings.

### BRIEF DESCRIPTION OF THE FIGURES

FIG. 1. is a block diagram illustrating the distributed nature of the watermarking technique.

FIG. 2 is a flow chart depicting the sequence of events necessary for the watermarking application to insert watermarks in a digital work.

FIG. 3 is a flow chart depicting the sequence of events necessary for the watermarking application to analyze a digital work and relay the information gathered to a Meta-Data Database.

FIG. 4 is a diagram illustrating a sample graph of an audio file and the regions of the file to be watermarked

FIG. 5 is a flow chart depicting the sequence of events necessary for the watermarking application to process a request to insert watermarks into a digital work.

FIG. 6 is a block diagram illustrating the communications between the Meta-Data Database and Watermarking application that allows for transfer of Meta-Data of a new digital work.

FIG. 7 is a block diagram illustrating the communications between the Meta-Data Database and Watermarking application that allows for the real-time insertion of the Watermark.

FIG. 8 is a flow chart depicting the sequence of events necessary to extract watermark data from a digital work.

FIG. 9 is a flow chart depicting the sequence of events necessary to search for digital works that are similar to a given digital work.

FIG. 10 is a flow chart depicting the sequence of events necessary to enable blocking distribution of digital works suspected of being unauthorized copies of digital works.

### DETAILED DESCRIPTION OF THE INVENTION

The present invention is directed toward a system and method for real-time, distributed, unique, watermarking to provide trace-ability and copyright protection of digital content.

### Real-time Insertion of Watermark in a Distributed System

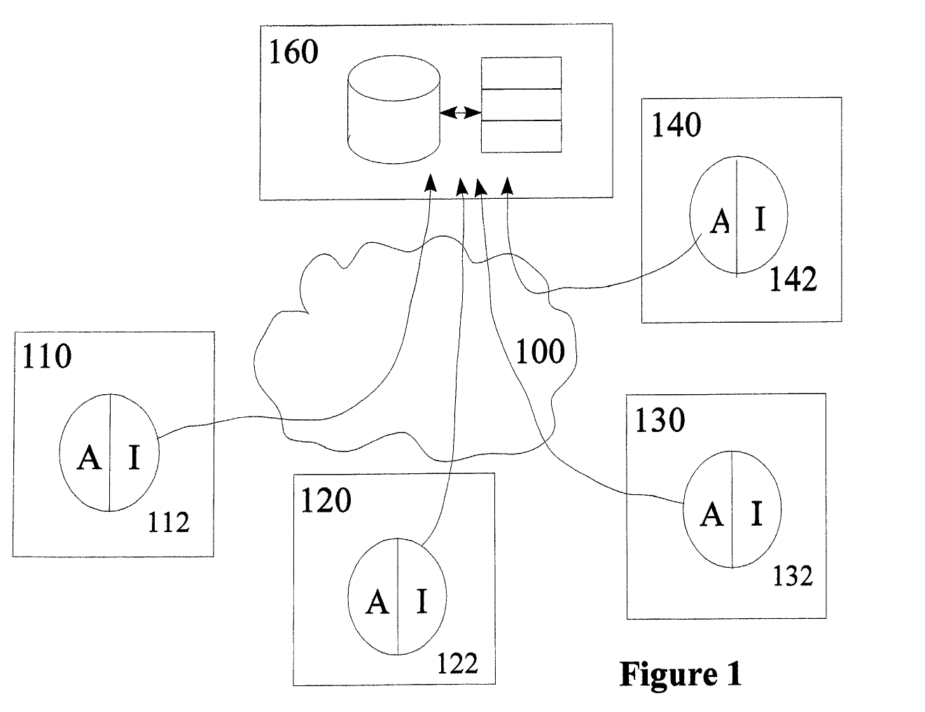

FIG. 1 is a block diagram illustrating an integrated system that enables real-time insertion of watermarks and the distributed nature of the watermarking application. A network 100 is a computer network such as the Internet, which allows multiple devices to be communicatively coupled together. In this example embodiment, the network 100 utilizes the Internet Protocol (“IP”) to enable this communicative coupling, and the network 100 includes both wire/fiber and wireless network components.

Alternative network environments include any “Future Net” and its accompanying network protocols, which will likely encompass the functions now provided by today's Internet, cable and broadcast television, telephone communications and other linear and interactive business and telecommunications systems. In an alternative embodiment, a second network (not shown) is used to provide highly secure communications. For example, in one embodiment, the second network is a proprietary network connecting the various content producers, distributors, content encoders, storage facilities and e-tailers used to provide highly secure communications. As such, the description of this example embodiment should not be construed to limit the scope and breadth of the present invention.

Coupled with the network 100 are digital works producers 110, distributors 120, e-tailers 130, and customer access devices 140. In one embodiment these are Web sites running on dedicated servers. These Web sites include digital-works producers, encoders, distributors, storage facilities, and e-tailers. Alternative embodiments include multiple servers for each web sites or user interfaces that use hyper linking protocols other than the Hypertext Transfer Protocol (“HTTP”). Examples of Web server software that can be used to construct such systems include Apache, Microsoft Internet Information Server, Netscape Enterprise Server, ATG dynamo, Web Logic and Web Sphere. The web server software can be designed to run on any number of computer hardware platforms with any number of operating systems and utilizing any number of programming languages for implementing scripts.

Also coupled to the network is a remote system 160. In one embodiment, this system is a centralized web server for coordinating requests for meta-data to enable real-time insertion of watermarks. This remote system also includes storage facilities for Meta-Data. “Meta-Data” as used herein is the mathematical information describing the areas of the digital work that are most suitable for insertion of watermarks. It is also the fingerprint of the digital work. Fingerprint as used herein indicates the unique mathematical characteristics of a particular digital work. Throughout this disclosure meta-data and fingerprint meta-data are used interchangeably to indicate the special and unique characteristics of a digital work. In one embodiment, this system is communicatively coupled to watermark application 112, 122, 132, 142.

In one embodiment, the system is configured in a distributed architecture, wherein databases and processors within the remote system are housed in separate units or locations. Some units perform the primary processing functions and contain, at a minimum, memory and a general processor. Each of these units is attached to a wide area network (“WAN”) hub which serves as the primary communications link with the other units and interface devices. The WAN hub may have minimal processing capability itself, serving primarily as a communications router. Those skilled in the relevant art(s) will appreciate that an almost unlimited number of servers may be supported. This arrangement yields a more dynamic and flexible system, less prone to catastrophic hardware failures affecting the entire system. In an alternative embodiment, the remote network is configured in a distributed fashion, such that a separate system is configured in a distributed fashion, such that a separate system is located in each geographical region and maintains communications with all other remote systems.

Watermarking applications 112, 122, 132, 142 are responsible for watermarking passed static content or dynamic stream blocks. The watermarking application can be written in any number of computer implemented programming languages such as C and C++. In one embodiment, they enable real-time watermarking of a digital work being delivered to a customer such that the watermark(s) identifies an association between the Distributor, the customer, the e-tailer, the remote system or some combination of these, for that transaction, thereby enabling trace-ability. As used herein, “real-time” typically includes communications that occur almost instantaneously and which experience only small delays between sending and receiving communications, however, large delays may occur between the sending and receiving of “real-time” communications while remaining within the scope of the invention.

The watermark application puts watermarks in digital works to identify future copyright violations. The watermark(s) can be a character string indicating such an association or a numerical identifier that references such an association stored by the network, the producer, the retailer or some combination of these. The watermark also includes the fingerprint information of the digital work. A unique watermark is generated by utilizing a combination of the fingerprint of digital work, along with a unique transactional identity that identifies the association between the content identity, and the public key. A fingerprint is created by studying the digital work to determine its unique characteristics. If for example, a sample sound wave may have several peaks and valleys of varying lengths and characteristics. An example fingerprint may be 3H1L indicating that this particular digital work has 3 peaks and 1 valley. The fingerprint can also be characterized as the unique mathematical information of the signal characteristics of the particular digital work. The foregoing examples is for illustrative purposes only. Thus this invention should not be limited to this particular description. This invention fully contemplates alternative methods of characterizing a digital work.

In this embodiment, the watermark application can be further divided into an inserter component as illustrated by 112i, 122i, 132i and 142i and an analyzer component 112a 122a, 132a, 142a. The inserter component of the application, inserts watermarks in pre-determined portions of a digital work. The application knows which of the pre-determined portions of the digital work to insert the watermarks based on the Meta-Data it receives from its own cache or the Meta-Data database residing in a remote location. The inserter component is capable of watermarking a live stream as well as a complete downloaded file. During a live stream of a digital work, the watermark inserter would receive a stream block of digital work, the inserter will either insert watermarks in the block based on Meta-Data it already has or it will analyze the block as it is being streamed to determine the most appropriate places to insert the watermarks. Analyzer component and Inserter component will be capable of synchronizing so that the stream block is analyzed and watermark is inserted simultaneously. For live broadcasts, the watermarks must be generated so that each individual stream has a unique transaction identity associated with the stream and a unique watermark series number. The watermarking application will insert each unique watermark for each stream of the broadcast of a digital work at the site where the broadcast is occurring.

The analyzer component of the watermarking application is an algorithm that reads the file that contains a particular digital work, determines which portions of the file are most suitable for watermarking and then relays the information regarding the particular work as Meta-Data to the Meta-Data Database which can be local or remote to the insertion location

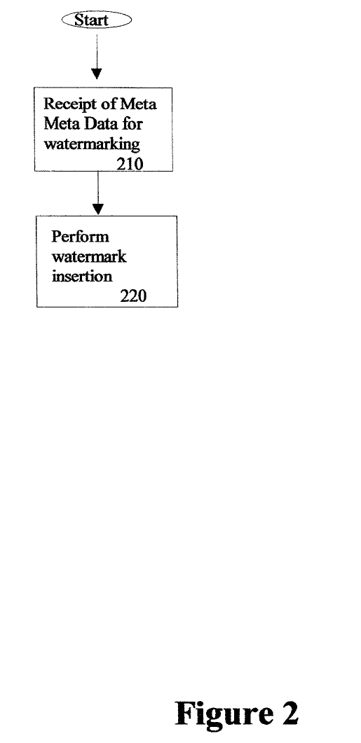

FIG. 2 is a flow chart illustrating how the watermark application inserts watermarks in a digital work. It begins with step 210 in which the application receives Meta-Data of Digital Work including the Watermark either from a local cache or the remote system containing the Meta-Data Database. The Meta-Data contains an algorithm that conveys information and instructions regarding which portions to insert the Watermarks into the digital work. In step 220, the application reads the file containing the digital work and inserts watermarks in the portions of the file indicated by the Meta-Data.

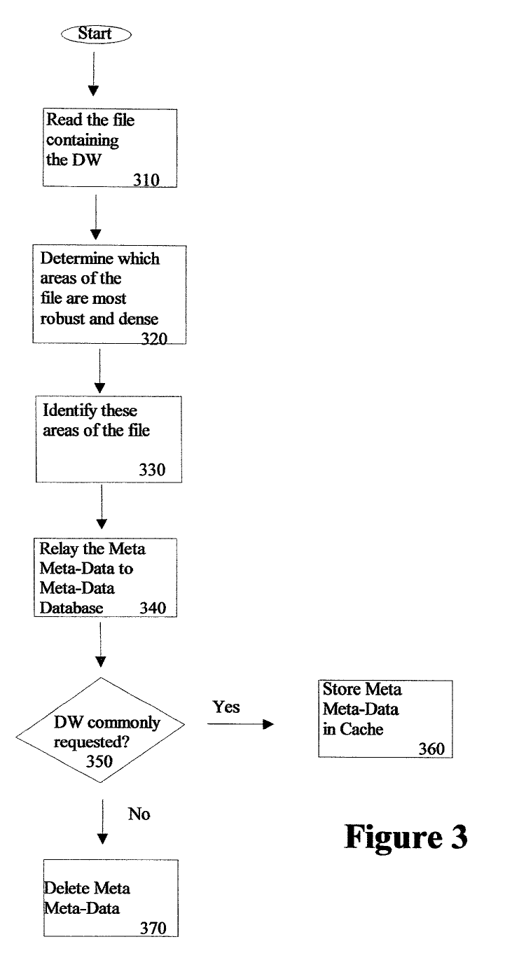

FIG. 3 is a flow chart illustrating how the watermark application analyzes a new digital work to determine its Meta-Data. It begins with step 310, in which the application reads the file containing the digital work. In step 320, the application determines which areas of the file are most robust and dense so that it can successfully insert a watermark that will be imperceptible and/or inaudible and also prevent others from extracting the watermark because extraction of a watermark from these portions will result in a distorted file. In step 330, the application identifies these portions of the file. In step 340, the application relays the Meta-Data to the Meta-Data Database. Meta-Data as used herein refers to the mathematical analysis of the digital work. In step 350, the application queries whether this digital work is one of the works that is most commonly requested based on a list of commonly requested digital works. If it determines that it is a commonly requested digital work, it stores the Meta-Data in its local cache. If it determines that it is not a commonly requested digital work, it deletes the information upon relaying it to the remote system containing the Meta-Data Database.

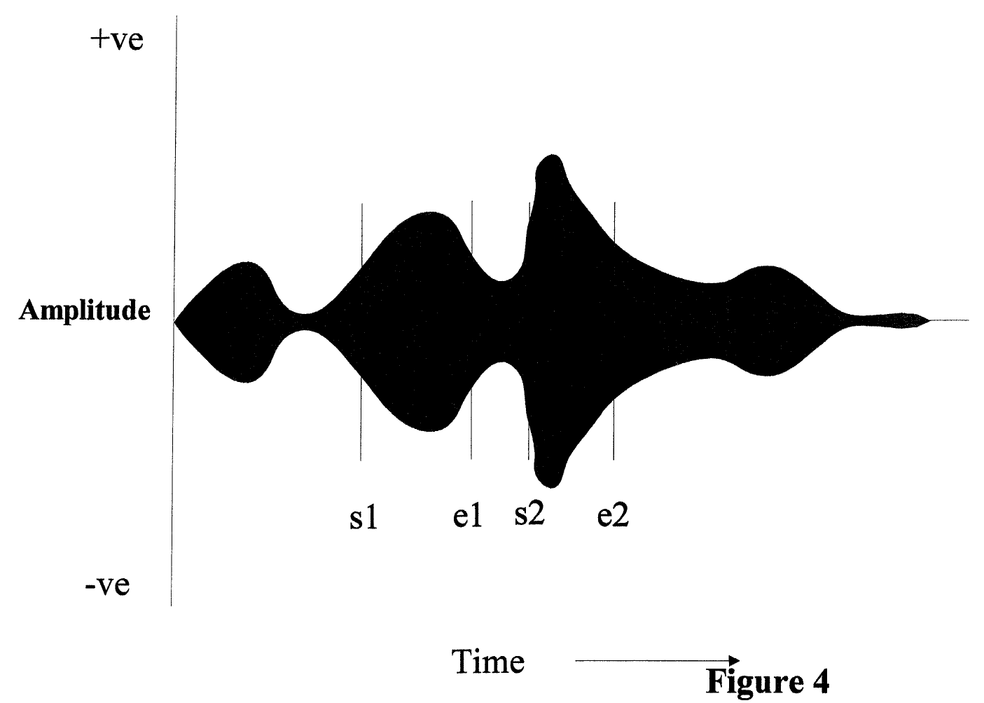

FIG. 4 is a diagram illustrating the appropriate portions to insert watermark(s). In this example embodiment, the graph indicates a sample waveform of a digital work. The analyzer application reads the file containing the digital work to determine the portion of the wave file that are the bulkiest, most powerful and produce the maximum noise. Once it has determined that these are portions of the file that will withstand insertion of a watermark, it identifies those portions by recording the coordinates and ranges of the waveform so that when the digital work is ready for watermark insertion, the inserter can simply locate those areas and inserts a given watermark in those portions of the file. Insertion of the watermark in the dense areas of a digital work allow the violation of even minute pieces of the work to be detected. Also, the watermark is made to be robust when inserted in these areas because removal of the watermark is easily detected.

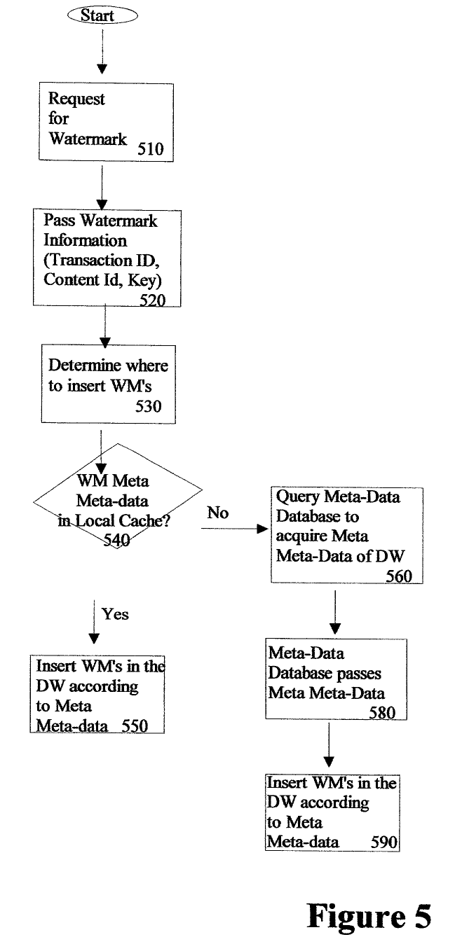

FIG. 5 is a flow chart depicting event sequence for processing of a request to watermark a digital work at a distributor's site. It begins with step 510 with the application receiving a request to watermark a digital work. In step 520, along with a request to watermark a given file, the watermarking application must be passed the watermark itself.

The watermark will contain a transaction ID, content Id and public and private key at a minimum. It may also contain such Meta information such as the copyright owner of the digital work, the producer identity of the digital work and any other information that the digital work's owner will want to include in the watermark.

In Step 530, the application must determine where to insert the watermarks in the digital work. In step 540, the application will query whether the Meta-Data indicating the proper portions of the digital work to insert watermarks is available in local cache? If yes, in step 550, it will insert the given watermarks in the digital work according to the information passed by the Meta-Data. If it is not available in the local cache, in step 560, the application will query the Meta-Data Database to acquire Meta-Data for the particular digital work. The Meta-Data Database will then pass the Meta-Data in step 570. The meta-data may also be passed along with the watermark or the transaction id.

In step 580, upon receiving the Meta-Data, the watermarking application will insert the given watermarks in the digital work according to the information passed by the Meta-Data. The local cache will store Meta-Data of the most commonly requested digital works in order to enhance the real-time nature of the watermarking technique. Periodically, the local cache may erase Meta-Data as the digital work becomes less popular and the need to watermark it is less likely.

The Meta-Data is housed in a central repository of remote system so that real-time insertion of watermarks is enabled. Due to the distributed nature of the Internet, a particular digital work may be requested at various points of presence, therefore, a central repository that stores the Meta-Data regarding all the digital works available will ensure that at a given moment when a digital work is distributed, the watermarking application can contact the Meta-Data Database or local cache and obtain Meta-Data and insert the watermarks in the appropriate places before distribution.

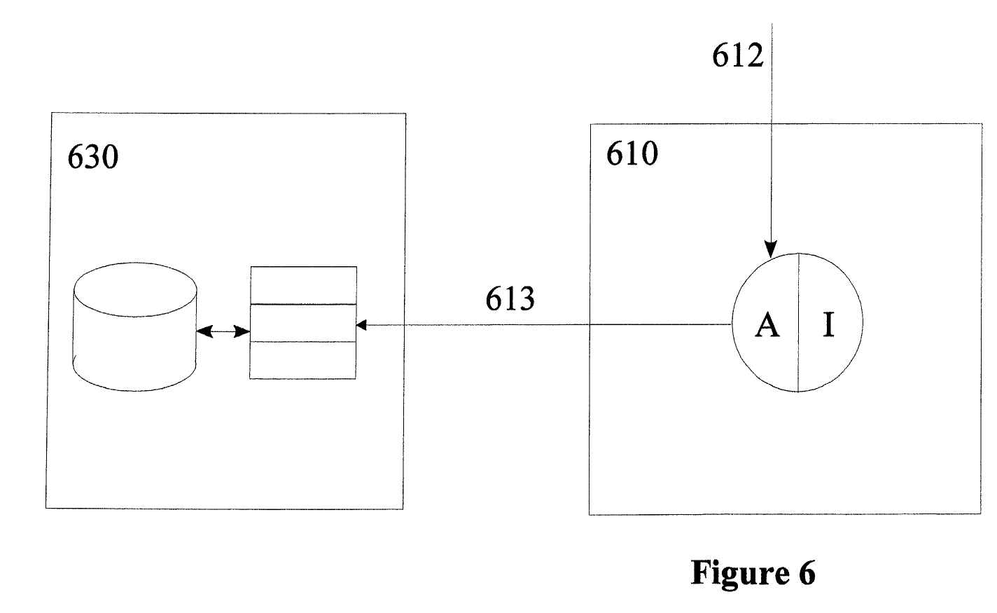

FIG. 6 is a block diagram illustrating event sequence and message flow between the watermarking application 610 and remote system 630. In Step 612, the watermarking application receives a notice of the availability of a new digital work. It then sends communication 614. Communication 614 will pass the analyzed Meta-Data of the new digital work to the Meta-Data Database for storage in case a request for watermarking that digital work arises in the future.

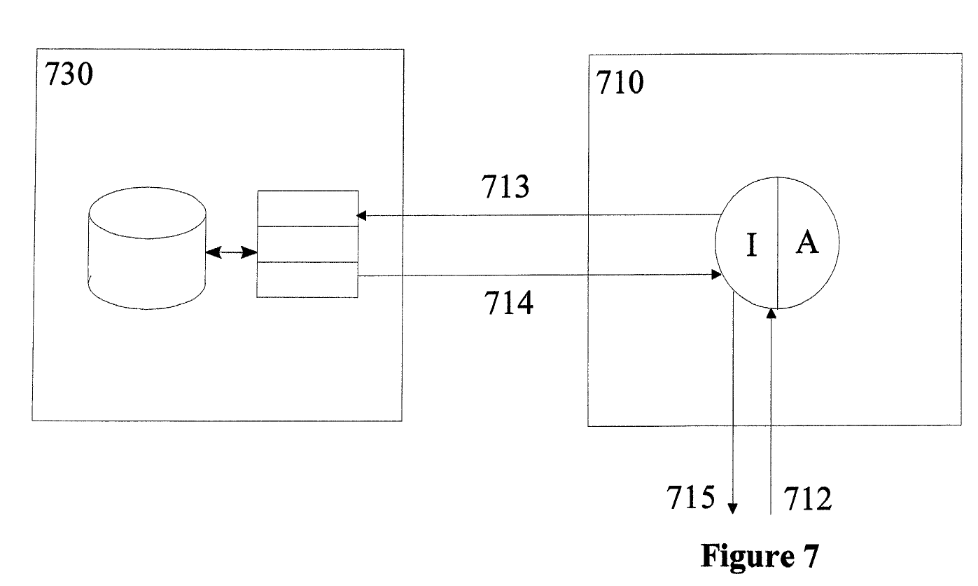

FIG. 7 is a block diagram illustrating event sequence and message flow between the watermarking application 710 and remote system 730. In Step 712, the watermarking application receives a request to insert digital work. It then sends a communication 714 to the remote system 730. Communication 714 requests Meta-Data regarding a particular digital work. The remote system then sends communication 716 that passes Meta-Data to the watermark application inserter. The inserter then follows the algorithm passed in Meta-Data to insert watermarks in the digital work. Communication 718 passes the watermarked digital work to the requester.

The present invention also discloses a method by which the Distributor is capable of handling requests for many watermarks. For example, in an example scenario, a Distributor may be requested to stream an audio file for multicasting. For example a request to watermark a 1000 streams of a digital work may be requested from a remote area and simultaneously another request for 2000 streams may be received from another remote area. Multicast is communication between a single sender and multiple receivers on a network. Together with anycast and unicast, multicast is one of the packet types in the Internet Protocol Version 6 (IPv6). For live broadcasts, the watermarks must be generated so that each individual stream has a unique transaction identity associated with the stream and a unique watermark series number. The watermarking application will insert a unique watermark for each stream of the broadcast of a digital work at the site where the broadcast is occurring in between stream blocks.

Although the invention is disclosed herein in terms of HTTP for communications and XML for data exchange, the present invention fully contemplates the use of other high-level protocols residing over TCP/IP such as WAP (Wireless Application Protocol), and variants of HTTP such HTTPS (Hypertext Transfer Protocol Secure) and HTTP-NG (Hypertext Transfer Protocol-Next Generation) and alternative hypertext markup languages such as WML (Wireless Mark-Up Language) wireless protocols with 2G and 3 G networks. Moreover, the present invention fully contemplates the use of other networking protocols, both high-level and low-level, including those not yet developed.

### Unique Hybrid Fingerprint-Watermark Technique

The present invention also a discloses a method of combining unique watermarking with digital fingerprinting. The watermark(s) can be a character string indicating such an association or a numerical identifier that references such an association stored by the network, the producer, the retailer or some combination of these. A unique watermark is inserted by utilizing a combination of the fingerprint of digital work, along with a unique transactional identity that identifies the association between the content identity, the transaction identity and the public key. A fingerprint is created by studying the digital work to determine its unique characteristics. For example, a sample sound wave may have several peaks and valleys of varying lengths and characteristics. An example fingerprint may be 3H1L indicating that this particular digital work has 3 peaks and 1 valley as indicated by its sample sound wave. The fingerprint can also be characterized as the unique mathematical information or meta-data of the particular digital work. The fingerprint information is thus used to identify a unique signature. This signature is used to insert the watermark in the digital work in its unique areas and to extract the watermark from various parts of the digital work using the fingerprint information. By combining the transaction identity, the content identity and mathematical information of the digital work to create the watermark, a unique hybrid fingerprint watermark technique is used.

### Security of Watermark

The present invention also discloses a method of making the watermark secure in order to prevent hacking. Given an original un-watermarked signal and its watermarked component, it is impossible to subtract the watermarks. This technique utilizes public key cryptography with private key cryptography. For example, in public key cryptography, a public and private key are created simultaneously using the same algorithm by a certificate authority. The private key is given only to the requesting party and the public key is made publicly available (as part of a digital certificate) in a directory that all parties can access. The private key is never shared with anyone or sent across the Internet. An authorized entity can use the private key to decrypt the watermark that has been encrypted with the public key. Thus, only an authorized entity can decipher the watermark and prevent hackers from manipulating it.

### Extraction Mechanism

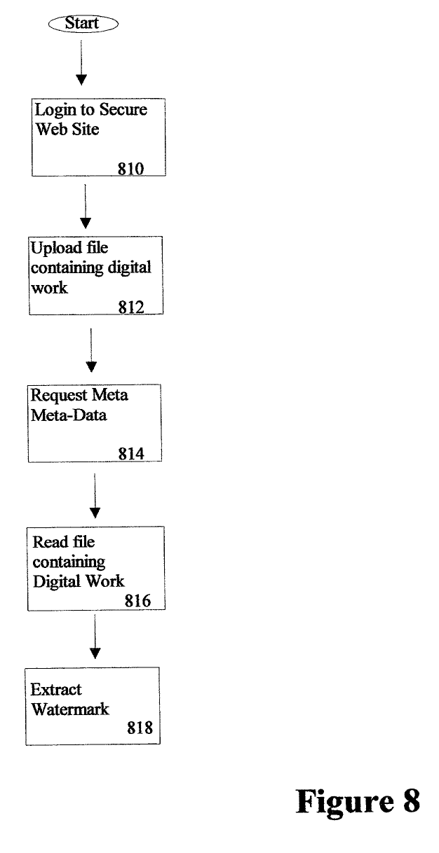

In one embodiment, the present invention discloses a system and method of extracting a watermark from a digital work FIG. 8 is a flow chart describing the events necessary for extraction of watermarks from a given file. The method involves the interested party to login to a secure web site on the remote watermarking system. Step 810 begins with an interested party login to a secure site. In step 812, the interested party must upload the file containing the digital work suspected of being an illegal copy. In step 814, the watermark extractor application will request Meta-Data of the digital work from Meta-Data Database to determine the most robust and bulky areas of the digital work. In step 816, the extractor application will read the digital file and refer to the Meta-Data to determine where the watermarks are. In step 818, the extractor will extract the watermarks from those areas. If the watermark indicating the true owner or licensee does not match with the current possessor of the digital work, a copyright violation may have occurred. Also, by extracting all the watermarks in a given digital work, the extractor will produce an audit-trail indicating how and when the digital work was transferred from one entity to another.

Audit-Trail

The present invention discloses a system of watermarking that will insert unique watermarks at each transactional stage to provide a complete audit-trail. For example, a simplified version of content delivery system may encompass a content producer, a content encoder, a content distributor and an e-tailer. The present invention enables the insertion of a watermark at each transactional stage so that when a content producer delivers the digital content to an encoder, before the moment of transfer from producer to encoder, a watermark identifying, the content producer and content encoder through a transaction identity, a content identity and public key is inserted. The watermark application will insert watermarks that are a watermark series number, mastering facility identity, copyright holder identity, distributor identity, clearinghouse identity, e-tailer identity, and consumer identity. At the mastering facility, the watermarking application will embed a watermark in the first segment and reserve 8 segments of the digital work to insert watermarks in the future. In the second pass the copyright holder watermark will be embedded and so on till it reaches the consumer and all 8 segments of the digital work have been utilized.

Real-time Search of Similar Digital Works

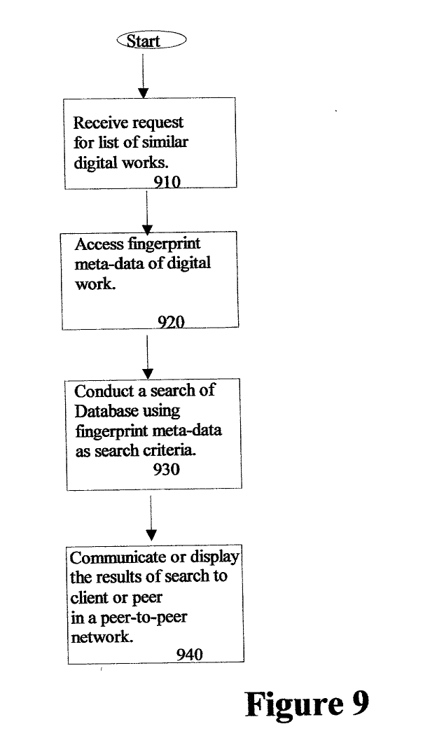

In one embodiment, the present invention discloses a method of searching for similar digital works based on the fingerprint meta-data of the digital work for which fingerprint meta-data is known. FIG. 9 depicts the steps necessary to search for digital works that bear similar characteristics of a given digital work. In step 910, the remote system receives a request to generate a list of digital works that are similar to a given digital work. In step 920, the system then accesses the fingerprint meta-data of the given digital work. In step 930, based on the fingerprint meta-data, the system conducts a search of its database using as its search criteria the fingerprint meta-data of the given digital work. In step 940, the system communicates and or displays the results of the search to its client or peer in peer-to-peer network.

Real-time Blocking of Distribution of Suspect Digital Works

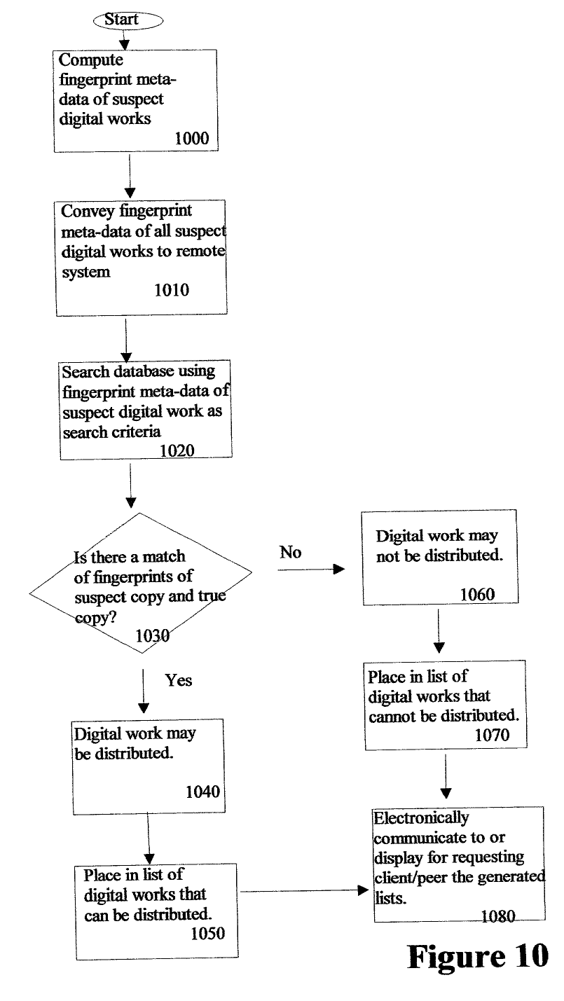

In one embodiment, the present invention discloses a method of enabling real-time blocking of distribution of digital works suspected to be unauthorized copies. FIG. 10 depicts the steps necessary to enable blocking distribution of unauthorized copies of digital works. In step 1000, the application on the client or peer in a peer-to-peer network, computes the fingerprint meta-data of the digital works suspected of being unauthorized copies of digital works. In step 1010, the application conveys the fingerprint meta-data of all the works that it believes are unauthorized copies to the remote system. In step 1020, the remote system, then searches its database of fingerprint meta-data using as search criteria the fingerprint meta-data of the suspect digital work. In step 1030, the system queries if the search results in matching of the suspect copy with that of the true copy. If there is no match, then in step 1040, it will determine that this particular digital work is an authorized copy. In step 1050, the digital work is placed in a list of digital works that may distributed. The system will either display or electronically communicate the list of confirmed authorized copies to the client or peer requesting this service. In step 1060, if the search results in a match between the suspect copy and the true copy, the system determines that it is indeed an unauthorized copy. In step 1070, it then places the digital work in a list of digital works to blocked from distribution. In step 1080, it then electronically communicates and/or displays the resulting lists to client or peer requesting this service. Thus the system will go through all suspect digital works and generate a list of digital works confirmed to be unauthorized copies. This method is designed to enable copyright holders to prohibit distribution of unauthorized copies of digital works by providing a list of suspect digital works, calculating the fingerprint meta-data of the digital works and searching for a “match” of the suspect digital works with that of the true digital work. If a match is found, the copyright holder knows that the suspect digital file is indeed an unauthorized copy and thereby prohibit its distribution in a peer-to-peer network.

In one embodiment, the parameters that go into the various communications described above are as follows:

Watermarking Inserter Component
Input Parameters:

| | |
|---|---|
| InLocationPath | http://MusicStorage.distributor.net/sherylcrowbeloved.mp3 |

| | |
|---|---|
| Watermarking Meta-Data | s1,e1,s2,e2,s3,e3,s4,e4, |

| | |
|---|---|
| Transaction Tag | 17777678888888888 |
| ContentId | 123456789abcdef |

Output Parameters:

| | |
|---|---|
| OutLocation | http://StreamArea.distributor.net/sherylcrowbelovedWM.mp3 |

| | |
|---|---|
| Transaction Tag | 17777678888888888 |

Watermarking Analyzer Component
Input Parameters:

| | |
|---|---|
| InLocationPath | http://MusicStorage.distributor.net/sherylcrowbeloved.mp3 |

Output Parameters:

| | |
|---|---|
| Watermarking Meta-Data | 1acd13bf6789edf656 |

Watermarking Extractor Component
Input Parameters:

| | |
|---|---|
| InLocationPath | http://DigitalWorkUpload.clearinghouse.net/mymadonna.mp3 |

Output Parameters:
Audit-Trail
TimeStampTransactionTag1ContentId_TimeStampTransactionTag2ContentId_{—}
TimeStampTransactionTag3ContentId_TimeStampTransactionTag4ContentId_TimeStamp
TransactionTag5ContentId_TimeStampTransactionTag6ContentId_TimeStampTransaction
Tag7ContentId_TimeStampTransactionTag8ContentId

In addition, as mentioned previously, in one embodiment, all communications are implemented using SSL.

While various embodiments of the present invention have been described above, it should be understood that they have been presented by way of example only, and not limitation. It is to be understood that the description and drawings represent the presently preferred embodiment of the invention and are, as such, representative of the subject matter which is broadly contemplated by the present invention.

Furthermore, the scope of the present invention fully encompasses other embodiments that may become obvious to those skilled in the relevant art(s). For example, reference characters used to designate claim steps are provided for convenience example, reference characters used to designate claim steps are provided for convenience of description only, and are not intended to imply any particular order for performing the steps. Thus, the breadth and scope of the present invention should not be limited by any of the above-described exemplary embodiments, but should be defined only in accordance with the following claims and their equivalents.

What is claimed is:

1. A method of enabling real-time watermarking of digital work(s) prior to distribution to third party(ies), the method comprising providing a remote system configured to communicate via a computer network and designed to coordinate collection and transmission of Meta-Data, and extraction of watermarks from a digital work, the method further comprising a step of providing a software application that is tethered to the remote system and is capable of analyzing a digital work to determine its Meta-Data and insert watermarks in a digital work prior to distribution.

2. The method of claim 1 wherein the application knows where to insert watermarks in a digital work based on Meta-Data it receives from a remote system or a local cache which houses Meta-Data of digital works.

3. The method of claim 1 wherein the application is capable of reading a digital file, determining the most robust, strong, dense areas of digital work.

4. The method of claim 3, wherein the watermark application records the coordinates of the areas of the watermark.

5. The method of claim 4, wherein the watermark application relays the Meta-Data of digital work to remote system and/or stores Meta-Data in its cache.

6. The method of claim 5, wherein the remote system comprises at least one database system to store Meta-Data regarding various digital works residing at different points of presence.

7. The method of claim 1, wherein the remote system comprises a web-enabled watermark extraction method.

8. A method of watermarking digital works in real-time and instantaneously comprising:
accessing fingerprint meta-data from database or local cache upon request to watermark; and
watermark digital work based on the fingerprint meta-data before delivery.

9. A real-time watermark analysis method comprising:
reading a file containing digital work;
determining the areas of the file that are the strongest, most powerful and robust;
recording the coordinates of the areas that are strongest, most powerful and robust;
passing this information to remote system which houses such information; and
storing the information collected in cache if digital work is often requested.

10. A real-time watermark insertion method comprising:
receiving watermark to insert;
receiving the fingerprint meta-data of digital work;
searching the file containing digital work for areas indicated by fingerprint meta-data; and
inserting the watermarks in those regions.

11. A real-time watermark extraction method comprising:
receiving a digital file suspected of being an illegal copy;
receiving the fingerprint meta-data for the digital work;
searching for the file containing the original work for areas that are strong and powerful based on fingerprint meta-data;
extracting the watermarks from those regions; and
displaying the extracted watermark or electronically communicating the violation of copyright or lack thereof.

12. A method of enabling real-time search of digital works that bear similar characteristics based on the meta-data of the digital work comprising:
accessing the meta-data of a given digital work;
searching in the meta-data database for digital works that are similar to the characteristics of the given digital work; and
displaying the results of the search or electronically communicating the results of the search.

13. A method of enabling real-time blocking of distribution of digital works suspected to be unauthorized copies comprising:
computing the meta-data of given digital work(s) on the client or a peer in a peer-to-peer network;
receiving a list of digital works that may need to be blocked along with their meta-data;
searching in the meta-data database for digital works that match the characteristics of the given work(s);
generating a list of digital works that should be blocked that match the given digital work; and
displaying and/or electronically communicating to client or peer in peer-to-peer network the list of digital works that should be blocked from further distribution.
